(19) United States
(12) Patent Application Publication
(10) Pub. No.: US 2005/0087896 A1
(43) Pub. Date: Apr. 28, 2005

(54) Method for producing optical circuit pattern and polymer optical waveguide

(75) Inventors: Shigemi Ohtsu, Ashigarakami-gun (JP); Keishi Shimizu, Ashigarakami-gun (JP); Kazutoshi Yatsuda, Ashigaakami-gun (JP); Eiichi Akutsu, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/866,731

(22) Filed: Jun. 15, 2004

(30) Foreign Application Priority Data
Oct. 22, 2003 (JP) 2003-361577

(51) Int. Cl. B05D 5/06; B29D 11/00

(52) U.S. Cl. 264/1.27; 427/553; 427/163.2; 264/1.7

(57) ABSTRACT

A method for producing an optical circuit pattern, including: forming a patterned concave portion in a layer of a water repellent and oil repellent polymer material, which has a property of being decomposed due to light having a wavelength in a range of 150 to 220 nm, by irradiating light having a wavelength in a range of 150 to 220 nm and thereby decomposing and removing the polymer material at an irradiated portion; and filling a resin material having a refractive index higher than that of the polymer material in the concave portion.

### CROSS-REFERENCE TO RELATED APPLICATION

This application claims priority under 35USC 119 from Japanese Patent Application No. 2003-361577, the disclosure of which is incorporated by reference herein.

### BACKGROUND OF THE INVENTION

1. Field of the Invention

The present invention relates to a method for producing an optical circuit pattern, and in particular, a polymer optical waveguide.

2. Description of the Related Art

As methods for producing an optical circuit pattern such as a polymer optical waveguide, (1) a method in which a film is impregnated with a monomer, followed by selectively exposing a core portion to alter the refractive index thereof, and further followed by laminating a film (selective polymerization method), (2) a method in which after a core layer and a clad layer are coated, a core portion is formed by reactive ion etching (RIE method), (3) a method of using a photolithography method in which a UV curable resin obtained by adding a photosensitive material to a polymer material is used and exposure and development thereof is carried out (direct exposure method), (4) a method utilizing injection molding, and (5) a method in which after a core layer and a clad layer are coated, a core portion is exposed to alter the refractive index of the core portion (photo-bleaching method) have been proposed.

However, in the selective polymerization method according to (1), there is a problem in the lamination of films; in the methods according to (2) and (3), the use of the photolithography method increases costs; and in the method according to (4), accuracy of an obtained core diameter is problematic. Furthermore, the method according to (5) has a problem in that the difference between the refractive indices of the core layer and the clad layer cannot be freely designed.

At present time, practical methods with excellent performance include only the methods according to (2) and (3). However, these methods have problems relating to cost as mentioned above. In addition, none of the methods according to (1) through (5) can be applied to form a polymer optical waveguide on a plastic substrate that is large in size and flexible.

Furthermore, as a method for producing a polymer optical waveguide, a method is known in which a polymer precursor material for a core is filled in a patterned substrate (clad) in which a pattern of grooves that become capillaries is formed, followed by curing to form a core layer, and further followed by laminating thereon a planar substrate (clad). However, according to the method, the polymer precursor material is thinly filled and cured to form a thin layer having a composition that is the same as that of the core layer, not only in the capillary grooves but also over the whole between the patterned substrate and the planar substrate. As a result, there is a problem in that light leaks through the thin layer.

Still furthermore, although it has not yet been established as a general method, a method in which an optical waveguide is formed by making use of printing has been considered. For instance, Japanese Patent Application Laid-Open (JP-A) No. 2002-14250 discloses a method in which an optical waveguide is formed by making use of an ink jet method. Furthermore, JP-A No. 2003-121674 discloses a method in which, by taking advantage of the hydrophilicity of titanium oxide, an optical waveguide is formed according to a printing method. However, none of these methods are suitable for practical use since a shape of a cross section of the optical waveguide is insufficient.

In this connection, recently, in IC technology and LSI technology, attention has been directed to the creation of optical interconnections, in place of high-density electrical interconnections, between devices, between boards in a device, and within a chip, for the purpose of improving operational speed and a level of integration.

As an element for optical interconnection, JP-A No. 2000-39530, for instance, discloses an optical element including a light-emitting element and a light-receiving element in a core-clad lamination direction of a polymer optical waveguide having a core and a clad that surrounds the core, and further including an input side mirror for inputting light from the light-emitting element to the core and an output side mirror for outputting light from the core to the light-receiving element, wherein in positions corresponding to optical paths from the light-emitting element to the input side mirror and from the output side mirror to the light-receiving element, a clad layer is formed in a concave shape, and light from the light-emitting element and light from the output side mirror are converged. Furthermore, JP-A No. 2000-39531 discloses an optical element in which light from a light-emitting element is inputted into a core end face of a polymer optical waveguide having a core and a clad surrounding the core, wherein a light input end face of the core is formed as a convex face facing the light-emitting element to converge light from the light-emitting element, and thereby suppress waveguide loss.

Still furthermore, JP-A No. 2000-235127 discloses an opto-electronic integrated circuit in which a polymer optical waveguide circuit is directly assembled on an opto-electronic combined circuit substrate on which electronic elements and optical elements are integrated.

In this connection, when the elements such as mentioned above can be bent in forming optical interconnections and incorporated in a device, the degree of freedom can be increased when devising the structure of optical interconnections, and as a result, a level of integration of ICs and LSIs can be improved.

However, the optical elements and the opto-electronic ICs all lack flexibility, and accordingly, it is impossible to bend the optical elements and the opto-electronic ICs for incorporation thereof into devices. Furthermore, the optical elements and the opto-electronic ICs are required to form an end face of a core in a convex shape and to be used together with a mirror, and accordingly, a complex structure has to be adopted. Reasons for forming the core end face in a convex shape and condensing light with a lens are as follows. On the hand, a semiconductor laser element as a light-emitting element that is used in the optical element and so on generates much heat, and when it is used by simply being brought into close contact with a polymer optical waveguide, the heat cannot escape and malfunction is caused. Accordingly, a gap is necessarily disposed between the polymer optical waveguide and the light-emitting element to let the heat escape. On the other hand, there is a divergence angle in a spot of a semiconductor laser (accordingly, since as the gap becomes larger, the light diverges more, and the light becomes more difficult to be confined in the optical waveguide).

Furthermore, although the optical elements and the photo-electronic ICs each include a polymer optical waveguide, since all of these are produced by use of the photolithography method, the process is complicated, and since there is a problem of waste liquid, a burden on the environment is large.

Thus, a flexible polymer optical waveguide sheet itself has not been at all provided. In addition to this, the idea of connecting a light-emitting element to an end face of a polymer optical waveguide sheet so as not to damage flexibility, and thereby forming an optical element that is used in an optical interconnection has not been at all proposed.

In this connection, use of a polymer optical waveguide that uses an amorphous fluorocarbon resin is known. However, since the fluorocarbon resin is deficient in workability, the RIE method is usually used to form an optical waveguide (see OFC 2003, PD34, Aydin Yeniay, et. al, “Ultra Low Loss Polymer Waveguide”, and “Proceedings of the 12^{th} International Conference on POF”, pp. 187-190 (2003)). Although the RIE method is an excellent fine processing technology, since it is a very expensive method, a polymer optical waveguide cannot be produced at low cost.

On the other hand, in “The Transactions of the Institute of Electrical Engineers of Japan C”, 116(12), pp. 1317 and 1319 (1996), it is disclosed that when a surface of a fluorocarbon resin is processed with excimer light to decompose organic substances, the surface can be thereby cleansed and rendered hydrophilic and adhesive. However, it has not been at all considered to form a concave pattern on the fluorocarbon resin with excimer light, and, going one step further, the idea of forming a concave portion on a fluorocarbon resin layer by irradiating excimer light followed by filling the concave portion with a core-forming resin and thereby producing a polymer optical waveguide has not been at all known.

### SUMMARY OF THE INVENTION

The present invention has been made in view of the above circumstances and provides a method for producing, very easily and at low cost, an optical circuit pattern including a polymer optical waveguide.

A first aspect of the present invention is to provide a method for producing an optical circuit pattern. The method includes: forming a patterned concave portion in a layer of a water repellent and oil repellent polymer material, which has a property of being decomposed due to light having a wavelength in a range of 150 to 220 nm, by irradiating light having a wavelength in a range of 150 to 220 nm and thereby decomposing and removing the polymer material at an irradiated portion; and filling a resin material having a refractive index higher than that of the polymer material in the concave portion.

A second aspect of the present invention is to provide a method for producing a polymer optical waveguide. The method includes: forming, on a substrate, a clad layer including a layer of a water repellent and oil repellent clad-forming polymer material having a property of being decomposed due to light having a wavelength in a range of 150 to 220 nm; forming a core patterned concave portion by irradiating light having a wavelength in a range of 150 to 220 nm on the clad layer and thereby decomposing and removing the polymer material at an irradiated portion; and filling a core-forming resin material in the concave portion to form a core.

According to the invention, an optical circuit pattern such as a polymer optical waveguide can be produced very easily and at low cost. Furthermore, according to the invention, a flexible and large-area optical circuit pattern that has less propagation loss, is high in accuracy, and can be freely incorporated in various kinds of devices can be produced very easily and at low cost. Furthermore, a shape of the optical circuit pattern such as a polymer optical waveguide can be freely designed. Still furthermore, since a surface of a resin material filled in the concave portion forms a hemisphere due to surface tension, in the case of, for instance, using a concave portion filled with a resin material as an optical waveguide core, an ideal optical waveguide core can be formed with a simple operation. Accordingly, in comparison with existing methods for producing an optical circuit pattern, a high-precision optical circuit pattern can be provided at very low cost.

Furthermore, when an end face of an optical circuit pattern such as a polymer optical waveguide is cut, an optical mirror surface can be obtained, and accordingly, an end portion can be directly connected to a connector or the like.

### BRIEF DESCRIPTION OF THE DRAWINGS

FIGS. 1A to 1D are conceptual diagrams showing steps of producing an optical circuit pattern according to the present invention.

### DETAILED DESCRIPTION OF THE INVENTION

The present inventors have found that when, on a layer of a water repellent and oil repellent polymer material having a property of being decomposed due to light having a wavelength in a range of 150 to 220 nm, light having a wavelength in the above range is irradiated, a concave portion is formed without leaving residue (the decomposed product is vaporized as decomposed gas into the atmosphere). Moreover, the inventors have also found that when a resin material other than the above-mentioned polymer material is coated on a surface of the concave portion of the layer or the layer is immersed in the resin material, the resin material can be easily filled in the concave portion and easily removed from a surface without the resin material adhering to a non-irradiated portion of the layer. Thereby, a method of very easily producing an optical circuit pattern such as a polymer optical waveguide has been found.

A method for producing an optical circuit pattern according to the present invention includes: forming a patterned concave portion in a pattern formation region of a layer of a water repellent and oil repellent polymer material that has a property of being decomposed due to light having a wavelength in a range of 150 to 220 nm by irradiating short wavelength light in the range of 150 to 220 nm and thereby decomposing and removing the polymer material at an irradiated portion; and filling, in the concave portion, a resin material having a refractive index higher than that of the polymer material. In the invention, the resin material is filled only in the concave portion and does not adhere to a surface of a layer of the polymer material. Accordingly, there is no need for removing the resin material. Reasons for the resin material being filled only in the concave portion are considered that, on the one hand, a surface of the concave portion formed in a layer of the water repellent and oil repellent polymer material is modified due to the light irradiation process and thereby the affinity with the resin material is improved, on the other hand, since a surface of the layer of the polymer material other than the concave portion maintains the water repellency and the oil repellency, the resin material is repelled.

A surface of the resin material filled in the concave portion forms a hemisphere due to surface tension; accordingly, for instance, when a concave portion filled with a resin material is used as an optical waveguide core, an ideal optical waveguide core can be formed with a simple operation. Furthermore, since the decomposed product is vaporized into the atmosphere and does not remain in the concave portion, an optical waveguide having excellent characteristics can be obtained. When the residue remains in the concave portion, the residue scatters light to cause large propagation loss, and the optical waveguide would not be practically usable.

Examples of an optical circuit pattern that can be produced according to the method of the present invention include a polymer optical waveguide (including branched polymer optical waveguide), a combination of a polymer optical waveguide and a diffraction grating, and small optical parts such as a lens. In the case where the optical circuit pattern is a polymer optical waveguide, a layer of a water repellent and oil repellent polymer material functions as a clad layer; the polymer material functions as a clad-forming polymer material; the patterned concave portion functions as a core patterned concave portion; the concave portion filled with the resin material functions as a core; and the resin material functions as the core-forming resin material. Hereinafter, a polymer optical waveguide will be explained as an example. However, the present invention can be applied to other optical circuit patterns in a similar manner.

[Method for Producing Polymer Optical Waveguide]

(Forming a core patterned concave portion in a layer of a water repellent and oil repellent clad-forming polymer material, which has a property of being decomposed due to light having a wavelength in a range of 150 to 220 nm, by irradiating light having a wavelength in a range of 150 to 220 nm and thereby decomposing and removing the polymer material at an irradiated portion).

Water Repellent and Oil Repellent Clad-Forming Polymer Material Having a Property of Being Decomposed Due to Light Having a Wavelength in a Range of 150 to 220 nm

The water repellency means a property of being wetted by water with difficulty such that when water is dropped on a surface of a layer of a polymer material, an angle that the surface forms with a liquid surface, that is, a contact angle becomes 90° or more, preferably 100° or more. Furthermore, the oil repellency means a property of being wetted by oil with difficulty such that when oleic acid is dropped on a surface of a layer of a polymer material, an angle that the surface forms with a liquid surface, that is, a contact angle becomes 90° or more, preferably 100° or more. The contact angle is obtained by measuring a contact angle when under a circumstance of 23° C. and 55% RH, on a surface of a layer of a polymer material, water or oleic acid is dropped and left for 10 s by use of a contact angle meter CA-X roll type (manufactured by Kyowa Interface Science Co., Ltd.).

When a clad-forming polymer material having such characteristics is used, the affinity of a surface of the concave portion with a core-forming resin material increases on the one hand; on the other hand, the high water repellency and oil repellency are maintained in a non-irradiated portion. Accordingly, a core-forming resin material can be easily filled in the core patterned concave portion on the one hand; on the other hand the core-forming resin material can be easily removed from the non-irradiated portion.

As the water repellent and oil repellent polymer material having a property of being decomposed due to light having a wavelength in a range of 150 to 220 nm, C—F bond containing polymer materials are preferable. Furthermore, the C—F bond containing polymer material is preferably one that further has at least one bond selected from the group consisting of a C—H bond, a C—C bond and a C—O single bond and does not contain a C═O double bond. This is because a bonding energy of a C═O double bond is 190.0 Kcal/mol that is large in the bonding energy of various kinds of chemical bonds, even when light in the range of 150 to 220 nm is irradiated to a polymer material having the C═O bond, the photo-decomposition is not likely to be effectively caused in a short time.

On the other hand, a bonding energy of a C—F bond is 115.2 Kcal/mol; that of a C—H bond, 97.6 Kcal/mol; that of C—C bond, 84.4 Kcal/mol; and that of a C—O single bond, 76.4 Kcal/mol. Accordingly, a polymer material that does not have a C═O bond and has, other than a C—F bond, at least one bond selected from the group consisting of a C—H bond, a C—C bond and a C—O single bond can be easily decomposed due to light in the range of 150 to 220 nm and can easily form a patterned concave portion. Among these, as a fluorocarbon resin that does not have a C═O double bond and has a C—F bond, a C—C bond and a C—O single bond, Cytop (manufactured by Asahi Glass Company) can be typically used.

Furthermore, the clad-forming polymer material is preferably transparent to light having a wavelength that is transmitted through a polymer optical waveguide. The refractive index thereof is preferably smaller than 1.55 and more preferably smaller than 1.50. Still furthermore, the refractive index is preferably smaller by 0.01 or more than that of the core-forming resin material.

Formation of a Layer (Clad Layer) of the Polymer Material

A method for producing a layer of the polymer material is not particularly limited. A layer formed as a film can be used as it is. Furthermore, in the case of a layer of the polymer material being formed on a substrate as described later, for instance, a method of coating an organic solvent solution of the resin, a method of hot-melt coating the resin and a method of laminating a film of the resin to a substrate with an adhesive can be raised. When a layer of the polymer material is formed, a clad layer is produced. Furthermore, as described later, in the case of a clad layer (upper clad layer) being further formed on a core formation layer, a bottom clad layer is formed.

In the case the layer of the polymer material is not to be disposed on a substrate, it would be sufficient if the layer of the polymer material has a thickness that is larger than a depth of the concave portion being formed and sufficiently works as a clad layer. Furthermore, in the case of a layer of the polymer material being disposed on a substrate that functions as a clad, a thickness of the layer has only to be a film thickness larger than a depth of a concave portion being formed.

Irradiating Light Having a Wavelength in a Range of 150 to 220 nm on a Clad Layer, Thereby Decomposing and Removing a Core-Forming Polymer Material at an Irradiated Portion, and Thereby Forming a Patterned Concave Portion

As light having a wavelength in a range of 150 to 220 nm, a xenon excimer lamp having a wavelength of 172 nm and an ArF excimer laser light having a wavelength of 193 nm are preferably used. However, as far as a wavelength is in the above wavelength range, whatever light sources may be used. Furthermore, when light is irradiated over an entire area, a photomask is used. An irradiation energy and time are appropriately controlled depending on a depth of the concave portion being formed.

According to the light irradiation, a core patterned concave portion is formed and a surface of the concave portion being formed increases the affinity to various kinds of resin materials. (Filling a core-forming resin material having a refractive index higher than that of the polymer material in a core patterned concave portion formed in the clad layer).

Core-Forming Resin Material Having a Refractive Index Higher Than That of the Polymer Material

A core-forming resin material that is filled in the concave portion is preferably transparent to light having a wavelength that is transmitted through a polymer optical waveguide. As the core-forming resin material, curable resins can be preferably used. As the curable resins, radiation curable, electron beam curable and thermosetting resins can be used. Among these, UV curable resins and thermosetting resins can be preferably used.

As the core-forming UV curable resin or thermosetting resin, UV curable or thermosetting monomer, oligomer or mixture of the monomer and the oligomer can be preferably used.

Furthermore, as the UV curable resin, epoxy-type, polyimide-type or acrylic UV curable resins can be preferably used.

The core-forming curable resin, in order to be filled in a concave portion formed in a layer of a polymer material having the water repellency and the oil repellency, is preferably not so high in the viscosity. The viscosity of the curable resin is, from a viewpoint of excellency in the core shape and low optical loss, preferably in the range of 10 to 2000 mPa·s, more preferably in the range of 20 to 1000 mPa·s, and still more preferably in the range of 30 to 500 mPa·s.

Other than this, a volume change before and after the curing of the curable resin is preferably small. For instance, when the volume decreases, the waveguide loss is caused. Accordingly, the curable resin is preferably as small as possible in the volume change, that is, it is 10% or less and preferably in the range of 0.01 to 4%. When a solvent is used to lower the viscosity, a volume change before and after the curing becomes larger; accordingly, it is preferably avoided.

In order to make the volume change (contraction) after the curing of the core-forming curable resin smaller, a polymer may be added to the resin. The polymer preferably has the compatibility with the core-forming curable resin and does not adversely affect on the refractive index, the elastic modulus and the transmission characteristics of the resin. Furthermore, by adding the polymer, other than the volume change being made smaller, the viscosity and the glass transition temperature of the cured resin can be highly controlled. Examples of the polymer include acrylic polymers, methacrylic polymers and epoxy polymers, but the polymer is not limited thereto.

The refractive index of a cured product of a core-forming curable resin is preferably in the range of 1.20 to 1.60 and more preferably in the range of 1.34 to 1.60.

The refractive index of the cured product of the core-forming curable resin is necessary to be larger than that of a layer of a polymer material that becomes a clad and has the water repellency and the oil repellency. The difference of the refractive indices of a core and a clad is preferably 0.01 or more.

Filling a Core-Forming Resin Material in a Concave Portion

In filling the core-forming resin material in the concave portion, according to a method in which a clad layer provided with a concave portion that is produced as mentioned above is immersed in a core-forming resin material or a method in which the core-forming resin material is coated on the clad layer provided with a concave portion, the filling can be easily performed. While the surface of the concave portion is increased in the affinity with the core-forming resin material, a surface where a concave portion is not formed maintains the water repellency and the oil repellency. Accordingly, due to the difference of characteristics of both surfaces, the core-forming resin material can be easily filled in the concave portion, and, since the core-forming resin material does not adhere to the surface where the concave portion is not formed, when the clad layer is pulled up from the core-forming resin material or when the clad layer is tilted, the core-forming resin material on the surface where the concave portion is not formed can be easily removed therefrom.

Furthermore, in a method for producing a polymer optical waveguide according to the invention, an upper clad layer is not indispensably formed. However, the upper clad layer (a polymer material layer) is preferably formed on a surface where the resin material has been filled in the concave portion (a pattern formation surface). The polymer material used to form the upper layer may be sometimes called as a second polymer material in order to distinct it from the clad-forming polymer material. However, the second polymer material is not necessarily a material different from the clad-forming polymer material; it may be the same as or different from the clad-forming polymer material.

Embodiments of the upper clad layer include a layer obtained by coating and curing a cladding curable resin, a polymer layer obtained by coating and a solvent solution of a cladding polymer material and one obtained by laminating a cladding film with an adhesive.

As the cladding curable resin, UV curable resins and thermosetting resins can be preferably used. For instance, UV curable or thermosetting monomers, oligomers or mixtures thereof can be used.

In order to make the volume change (contraction) of the clad-forming curable resin after the curing smaller, a polymer (for instance, methacrylic or epoxy polymer) that has the compatibility with the resin and does not adversely affect on the refractive index, the elastic modulus and the transmission characteristics of the resin can be added to the resin.

Furthermore, in view of the confinement of light, the refractive indices of the bottom clad layer and the upper clad layer are preferably substantially the same. Here, “the refractive indices being substantially the same” means not only there being no difference between the refractive indices of both but also the difference of the refractive indices of both being within 0.01. The difference of the refractive indices of both is preferably within 0.001 and more preferably zero.

Still furthermore, the polymer material that is used as the bottom clad layer in the invention, has the water repellency and the oil repellency and can be decomposed due to light having a wavelength in a range of 150 to 220 nm can be used also as the upper clad layer.

Furthermore, in the case where a material different from the bottom clad layer is used as the upper clad layer, on an entire surface of a core formation surface of the bottom clad layer, light having a wavelength in a range of 150 to 220 nm is preferably irradiated in advance to improve the affinity of a surface of the bottom clad layer to the upper clad layer.

Still furthermore, when a core end face of the polymer optical waveguide is cut, an optical mirror surface can be obtained and an end portion can be directly connected to a connector and so on.

(Substrate)

Furthermore, in the production of an optical circuit pattern according to the invention, a layer of the polymer material can be formed on a substrate. The production of a polymer optical waveguide will be explained as an example.

As the substrate, glass (quartz glass and so on) substrates, ceramic substrates, plastic substrates and Si substrates can be used without restriction. Furthermore, ones that are resin-coated on the substrates to control the refractive index can be also used. The substrate itself can be functioned as part of the clad layer, and, in this case, the refractive index of the substrate is smaller than 1.55 and preferably smaller than 1.40. Furthermore, the refractive index of the substrate is desirably smaller by 0.01 or more than that of the core-forming resin material. A thickness of the substrate is preferably in the range of 100 μm to 2 mm and can be appropriately selected depending on applications of the polymer optical waveguide.

The surface roughness (root-mean-square roughness (RMS)) of the substrate, in order to evade light scattering and make the propagation loss smaller, is preferably 0.1 μm or less.

Furthermore, when a flexible plastic substrate is used as the plastic substrate, a polymer optical waveguide flexible as a whole can be obtained.

A material of the plastic substrate is preferably one that is not decomposed due to light having a wavelength in the range of 150 to 220 nm. A material that has a C═O double bond and/or a C═C double bond in a polymer is one that is decomposed with difficulty even due to light having the wavelength. Examples of such a material include PMMA, polycarbonate and alicyclic olefinic resins. Among these, resins that are materials having at least one of a C═O double bond and a C═C double bond in a main chain of a polymer, that is, resins that have a norbornene structure in a main chain and alicyclic olefinic resins that have a norbornene structure in a main chain and a polar group such as an alkyloxy carbonyl group (alkyl groups having 1 to 6 carbon atoms and cycloalkyl group) in a side chain can be preferably used as resins difficult to decompose. Furthermore, since the alicyclic olefinic resins that have a norbornene structure in a main chain as mentioned above have excellent optical characteristics such as low refractive index (since the refractive index is in the neighborhood of 1.50, the difference of the refractive indices of the core and the clad can be secured) and high light transmittance, these can be particularly preferably used as the substrate in the invention. As a resin film having such characteristics, Arton film (manufactured by JSR Corp.) is preferable.

In the case of a material of the plastic substrate being one that is not decomposed due to light having a wavelength in the range of 150 to 220 nm, the plastic substrate can work as a stopper to the photoetching.

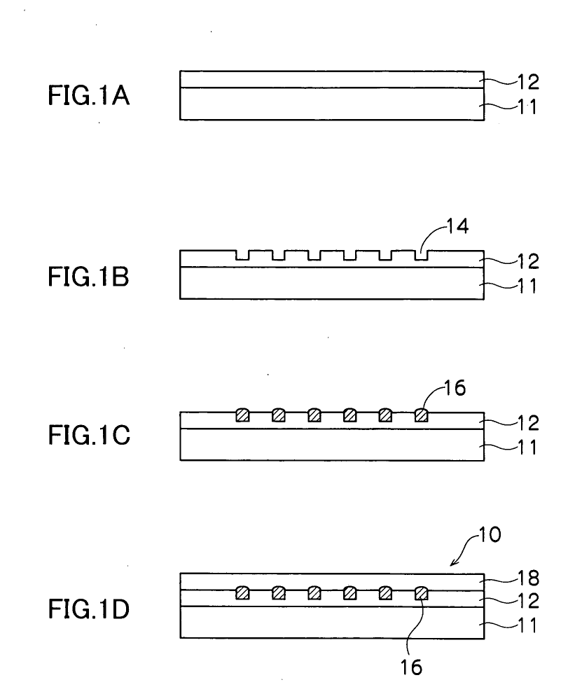

In the next place, a producing process of a polymer optical waveguide according to the invention will be explained with reference to FIGS. 1A to 1D. In FIGS. 1A to 1D, an example where a layer (bottom clad layer) of a water repellent and oil repellent polymer material that can be decomposed due to light having a wavelength in a range of 150 to 220 nm is formed on a substrate, and, with a UV curable resin as a core-forming resin material, an upper clad layer is further formed on a core formation surface is shown.

FIG. 1A shows a state where a bottom clad layer (layer of polymer material) 12 is formed on a substrate 11; FIG. 1B, a state where light in the range of 150 to 220 nm is irradiated on a core pattern formation region of the clad layer 12 to decompose and remove the polymer material at an irradiated portion, and thereby a core-patterned concave portion 14 is formed; and FIG. 1C, a state where a core-forming UV curable resin having a refractive index higher than that of the polymer material is filled in the core-patterned concave portion 14 followed by curing with UV light. Reference numeral 16 denotes a formed core. FIG. 1C shows that a surface of a core 16 is formed into a substantial hemisphere due to surface tension. Furthermore, FIG. 1D shows a state where an upper clad layer 18 is formed on a core formation surface, and, still furthermore, FIG. 1D shows a completed polymer optical waveguide 10.

Embodiments according to the present invention will be described below.

A first embodiment of the invention is a method for producing an optical circuit pattern, including: forming a patterned concave portion in a layer of a water repellent and oil repellent polymer material, which has a property of being decomposed due to light having a wavelength in a range of 150 to 220 nm, by irradiating light having a wavelength in a range of 150 to 220 nm and thereby decomposing and removing the polymer material at an irradiated portion; and filling a resin material having a refractive index higher than that of the polymer material in the concave portion.

A second embodiment of the invention is the method according to the first embodiment, wherein the layer of the polymer material is a clad layer, the concave portion where the resin material is filled is a core, and the optical circuit pattern is a polymer optical waveguide.

A third embodiment of the invention is the method according to the first embodiment, wherein the light is irradiated by a Xe excimer lamp and has a wavelength of 172 nm.

A fourth embodiment of the invention is the method according to the first embodiment, wherein the light is irradiated by an ArF excimer laser and has a wavelength of 193 nm.

A fifth embodiment of the invention is the method according to the first embodiment, wherein the polymer material includes a C—F bond.

A sixth embodiment of the invention is the method according to the fifth embodiment, wherein the polymer material further includes at least one selected from the group consisting of a C—H bond, a C—C bond and a C—O single bond and does not have a C═O bond.

A seventh embodiment of the invention is the method according to the first embodiment, wherein the layer of the polymer material is disposed on a substrate.

An eighth embodiment of the invention is the method according to the seventh embodiment, wherein the substrate has a surface roughness of 0.1 μm or less.

A ninth embodiment of the invention is the method according to the seventh embodiment, wherein the substrate is a film that includes a C═O bond and is not decomposed due to light having a wavelength in a range of 150 to 220 nm.

A tenth embodiment of the invention is the method according to the ninth embodiment, wherein the film has a refractive index of 1.55 or less.

An eleventh embodiment of the invention is the method according to the tenth embodiment, wherein the film is an alicyclic olefinic resin film.

A twelfth embodiment of the invention is the method according to the eleventh embodiment, wherein the alicyclic olefinic resin film includes a resin including a norbornene structure in a main chain and a polar group in a side chain.

A thirteenth embodiment of the invention is the method according to the first embodiment, wherein the resin material is a UV curable resin or a thermosetting resin.

A fourteenth embodiment of the invention is the method according to the first embodiment, further including forming a layer of a second polymer material having a refractive index substantially the same as that of the water repellent and oil repellent polymer material on a surface where the resin material has been filled in the concave portion.

A fifteenth embodiment of the invention is the method according to the fourteenth embodiment, further including, before forming the layer of the second polymer material, irradiating light having a wavelength in a range of 150 to 220 nm to a surface where the resin material has been filled in the concave portion.

A sixteenth embodiment of the invention is the method according to the fourteenth embodiment, wherein the second polymer material is water repellent and oil repellent and has a property of being decomposed due to light having a wavelength in a range of 150 to 220 nm.

A seventeenth embodiment of the invention is the method according to the fourteenth embodiment, wherein the layer of the second polymer material is formed by adhering a film of the second polymer material on the surface where the resin material has been filled in the concave portion, with an adhesive.

An eighteenth embodiment is a method for producing a polymer optical waveguide, including: forming, on a substrate, a clad layer including a layer of a water repellent and oil repellent clad-forming polymer material having a property of being decomposed due to light having a wavelength in a range of 150 to 220 nm; forming a core patterned concave portion by irradiating light having a wavelength in a range of 150 to 220 nm on the clad layer and thereby decomposing and removing the polymer material at an irradiated portion; and filling a core-forming resin material in the concave portion to form a core.

A nineteenth embodiment of the invention is the method according to the eighteenth embodiment, further including forming an upper clad layer on a surface where the core has been formed.

A twentieth embodiment of the invention is the method according to the nineteenth embodiment further including, after forming the upper clad layer, cutting an end portion of the produced polymer optical waveguide and thereby forming a core surface having an optical mirror surface.

### EXAMPLES

Hereinafter, the present invention will be more specifically explained with examples. However, these examples should not be construed to limit the scope of the invention.

### Example 1

On a Si substrate, Cytop (manufactured by Asahi Glass Company, refractive index: 1.34) is coated by means of a spin coating method followed by heating and curing at 150° C., and thereby a bottom clad layer having a film thickness of 10 μm is formed. Subsequently, an excimer lamp having a wavelength of 172 nm is irradiated to expose through a photomask having a width of 7 μm. An exposed portion is decomposed and vaporized due to the light and thereby a concave portion is formed. At this time, an exposure time (30 min) is controlled so that the exposure may be stopped at a depth of the concave portion of 5 μm, and thereby a concave portion having a width of 7 μm and a depth of 5 μm is formed. In the next place, a fluorinated acrylic resin (manufactured by NTT-AT Co.) that has the refractive index of 1.37 and is a core-forming UV curable resin is coated. Upon coating, the fluorinated acrylic resin is filled only in the concave portion, and, as shown in FIG. 1C, a filled surface forms a hemisphere. Thereafter, UV light is irradiated to cure a core portion. Further thereafter, on a core formation surface, Cytop having the refractive index of 1.34 is coated, heated and cured at 150° C. to form an upper clad layer (dry film thickness: 20 μm), and thereby a single mode polymer optical waveguide is produced.

### Example 2

A single mode polymer optical waveguide of Example 2 is produced in the same manner as in Example 1, except that the Si substrate of Example 1 is replaced by a glass substrate and that a core-forming UV curable resin is replaced by a core-forming thermosetting resin.

### Example 3

A single mode polymer optical waveguide of Example 3 is produced in the same manner as in Example 1, except that the Si substrate is replaced by an Arton film having a film thickness of 188 μm (manufactured by JSR Corp., refractive index: 1.509).

### Example 4

On an Arton film having a film thickness of 188 μm (manufactured by JSR Corp., refractive index: 1.509), Cytop (manufactured by Asahi Glass Company, refractive index: 1.34) is coated by means of a spin coating method followed by heating and curing at 150° C., and thereby a bottom clad layer having a film thickness of 10 μm is formed. Subsequently, through a photomask having a width of 12 μm, exposure is carried out with an excimer lamp having a wavelength of 172 nm. An exposed portion is decomposed and vaporized due to the light and thereby a concave portion is formed. At this time, an exposure time (30 min) is controlled so that the exposure may be stopped at a depth of the concave portion of 10 μm, and thereby a concave portion having a width of 12 μm and a depth of 10 μm is formed. In the next place, a core-forming UV curable fluorinated epoxy resin (manufactured by NTT-AT Co.) that has the refractive index of 1.42 is coated. Upon coating, the UV curable fluorinated epoxy resin is filled only in the concave portion. Furthermore, as shown in FIG. 1C, a filled surface is formed into a hemisphere. Thereafter, UV light is irradiated to cure a core portion. The formed core portion has a width of 12 μm and a height of 12 μm. Further thereafter, on a core formation surface, Cytop having the refractive index of 1.34 is coated, heated and cured at 150° C. to form an upper clad layer (dry film thickness: 20 μm), and thereby a single mode polymer optical waveguide is produced.

1. A method for producing an optical circuit pattern, comprising:
forming a patterned concave portion in a layer of a water repellent and oil repellent polymer material, which has a property of being decomposed due to light having a wavelength in a range of 150 to 220 nm, by irradiating light having a wavelength in a range of 150 to 220 nm and thereby decomposing and removing the polymer material at an irradiated portion; and
filling a resin material having a refractive index higher than that of the polymer material in the concave portion.

2. The method of claim 1, wherein the layer of the polymer material is a clad layer, the concave portion where the resin material is filled is a core, and the optical circuit pattern is a polymer optical waveguide.

3. The method of claim 1, wherein the light is irradiated by a Xe excimer lamp and has a wavelength of 172 nm.

4. The method of claim 1, wherein the light is irradiated by an ArF excimer laser and has a wavelength of 193 nm.

5. The method of claim 1, wherein the polymer material comprises a C—F bond.

6. The method of claim 5, wherein the polymer material further comprises at least one selected from the group consisting of a C—H bond, a C—C bond and a C—O single bond and does not have a C═O bond.

7. The method of claim 1, wherein the layer of the polymer material is disposed on a substrate.

8. The method of claim 7, wherein the substrate has a surface roughness of 0.1 μm or less.

9. The method of claim 7, wherein the substrate is a film that comprises a C═O bond and is not decomposed due to light having a wavelength in a range of 150 to 220 nm.

10. The method of claim 9, wherein the film has a refractive index of 1.55 or less.

11. The method of claim 10, wherein the film is an alicyclic olefinic resin film.

12. The method of claim 11, wherein the alicyclic olefinic resin film comprises a resin comprising a norbornene structure in a main chain and a polar group in a side chain.

13. The method of claim 1, wherein the resin material is a UV curable resin or a thermosetting resin.

14. The method of claim 1, further comprising forming a layer of a second polymer material having a refractive index substantially the same as that of the water repellent and oil repellent polymer material on a surface where the resin material has been filled in the concave portion.

15. The method of claim 14, further comprising, before forming the layer of the second polymer material, irradiating light having a wavelength in a range of 150 to 220 nm to a surface where the resin material has been filled in the concave portion.

16. The method of claim 14, wherein the second polymer material is water repellent and oil repellent and has a property of being decomposed due to light having a wavelength in a range of 150 to 220 nm.

17. The method of claim 14, wherein the layer of the second polymer material is formed by adhering a film of the second polymer material on the surface where the resin material has been filled in the concave portion, with an adhesive.

18. A method for producing a polymer optical waveguide, comprising:
forming, on a substrate, a clad layer including a layer of a water repellent and oil repellent clad-forming polymer material having a property of being decomposed due to light having a wavelength in a range of 150 to 220 nm;
forming a core patterned concave portion by irradiating light having a wavelength in a range of 150 to 220 nm on the clad layer and thereby decomposing and removing the polymer material at an irradiated portion; and
filling a core-forming resin material in the concave portion to form a core.

19. The method of claim 18, further comprising forming an upper clad layer on a surface where the core has been formed.

20. The method of claim 19, further comprising, after forming the upper clad layer, cutting an end portion of the produced polymer optical waveguide and thereby forming a core surface having an optical mirror surface.
